(19) United States
(12) Patent Application Publication
(10) Pub. No.: US 2017/0274952 A1
(43) Pub. Date: Sep. 28, 2017

(54) VEHICLE AND MOTORBIKE MONITORING SYSTEM AND APPARATUS THEREOF

(71) Applicant: HSIANG CHUN CHENG, Taichung City (TW)

(72) Inventor: HSIANG CHUN CHENG, Taichung City (TW)

(21) Appl. No.: 15/193,939

(22) Filed: Jun. 27, 2016

(30) Foreign Application Priority Data
Mar. 28, 2016 (TW) 105109694

(51) Int. Cl. B62J 3/00; B60C 23/04

(52) U.S. Cl. CPC B62J 3/00; B60C 23/0454; B62J 2006/008

(57) ABSTRACT

A vehicle and motorbike monitoring system and apparatus thereof are provided, including a monitoring apparatus, a computer, and a mobile device. The monitoring apparatus is connected with the computer to exchange information through a communication protocol therewith. The computer sends a status signal based on the equipment status of the vehicle/motorbike to the monitoring apparatus and sends a status information to the mobile device based on the status signal, such that the owner of the vehicle/motorbike know the equipment status. The owner sends a command information to the monitoring apparatus through the mobile device, and the monitoring apparatus subsequently sends a controlling signal to the computer, such that the equipment status changes. Therefore, safety and convenience of usage are enhanced.

### BACKGROUND OF THE INVENTION

1. Field of the Invention

The present invention relates to vehicle and motorbike monitoring system, and more particularly, to a vehicle and motorbike monitoring system and apparatus thereof with enhanced convenience of usage.

2. Description of the Related Art

Early vehicle remote controller is matched and connected with a vehicle in a manner of infrared transmission. In a short distance, the remote controller is pressed to lock/unlock the vehicle doors or to make the vehicle produce a sound for informing the driver of the vehicle position. Usually, the encryption method for the infrared transmission protocol set up by the vehicle manufacturer encrypts several units with binary encryption. However, when different vehicle owners get different remote controllers corresponding to different vehicles which have the same encryption arrangement, the remote controllers are able to lock/unlock the vehicles belonging to different owners, causing a potential safety risk. Further, both transmission distance and transmitting positions of infrared transmission are relatively limited in a small range. In other words, the infrared transmission is easily interfered by environmental objects, causing inconvenience of usage thereof.

Also, conventional vehicle remote controllers possess only the function to remotely lock/unlock the vehicle doors and remotely control the vehicle to produce sound. If the vehicle owner forgets to turn off the vehicle light, the vehicle remote controller is not able to provide a light off function. Therefore, regarding a conventional vehicle remote controller, both safety and convenience of usage are not assured.

### SUMMARY OF THE INVENTION

For improving aforementioned issues, embodiments of the present invention disclose a vehicle and motorbike monitoring system and apparatus thereof. When the monitoring apparatus is connected with the computer of a vehicle/motorbike, the monitoring apparatus and a mobile device are matched and exchange information with each other. Therefore, vehicle/motorbike owner is able to monitor the status of vehicle/motorbike equipment by use of the mobile device, enhancing the safety and convenience of usage.

For achieving the objectives, the embodiments of the present invention provided a vehicle and motorbike monitoring system, comprising:

a computer, provided with a first interface port, installed on a vehicle/motorbike, outputting a status signal based on a status of equipment on the vehicle/motorbike;

a monitoring apparatus, provided with a second interface port, a controller, a first communication module, and a displayer; the controller is connected to the second interface port, the first communication module, and the displayer; the second interface port is connected to the first interface port, wherein the second interface port receives the status signal and sends the status signal to the controller; the controller outputs a status information based on the status signal; the displayer displays the status of the equipment on the vehicle/motorbike; and

a mobile device, provided with a second communication module and a first touch screen displaying module, the second communication module and the monitoring apparatus connected and exchanging information with each other through a communication protocol, the second communication module receiving the status information and sending the status information to the first touch screen displaying module to be displayed on the first touch screen displaying module,

wherein the mobile device sends a command information to the monitoring apparatus through the communication protocol based on the status information; the controller generates a controlling signal based on the command information and sends the controlling signal to the first interface port though the second interface port, such that the computer based on the controlling signal commands the status of the corresponding equipment on the vehicle/motorbike to change.

With such configuration, the monitoring device is connected with the computer disposed on a vehicle/motorbike, such that the monitoring apparatus receives the status signal of the equipment on the vehicle/motorbike detected by the computer. Next, through the connection between the monitoring apparatus and the mobile device, the owner of the vehicle/motorbike by use of the mobile device receives the status information sent from the monitoring apparatus, thereby knowing the equipment status of the vehicle/motorbike. Also, the vehicle/motorbike owner is able to control the equipment status through the mobile device, so as to enhance the safety and convenience of usage.

### BRIEF DESCRIPTION OF THE DRAWINGS

FIG. 1 is a first block diagram of the system in accordance with the embodiment of the present invention which is applied on a vehicle.

FIG. 2 is a second block diagram of the system in accordance with the embodiment of the present invention which is applied on a motorbike.

FIG. 3 is a third block diagram in accordance with the embodiment of the present invention illustrating the connection between the monitoring apparatus and the computer on the vehicle/motorbike.

FIG. 4 is fourth block diagram in accordance with the embodiment of the present invention illustrating the connection between the monitoring apparatus and an external vehicle/motorbike electronic device.

FIG. 5 is a schematic view illustrating the vehicle/motorbike information displaying interface of the monitoring software in accordance with embodiments of the present invention.

FIG. 6 is a schematic view illustrating the controlling interface of the monitoring software in accordance with embodiments of the present invention.

FIG. 7 is a schematic view illustrating the function setting interface of the monitoring software in accordance with embodiments of the present invention.

FIG. 8 is a schematic view illustrating a vehicle controlled by the owner through a mobile device.

FIG. 9 is schematic view illustrating a motorbike controlled by the owner through a mobile device.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

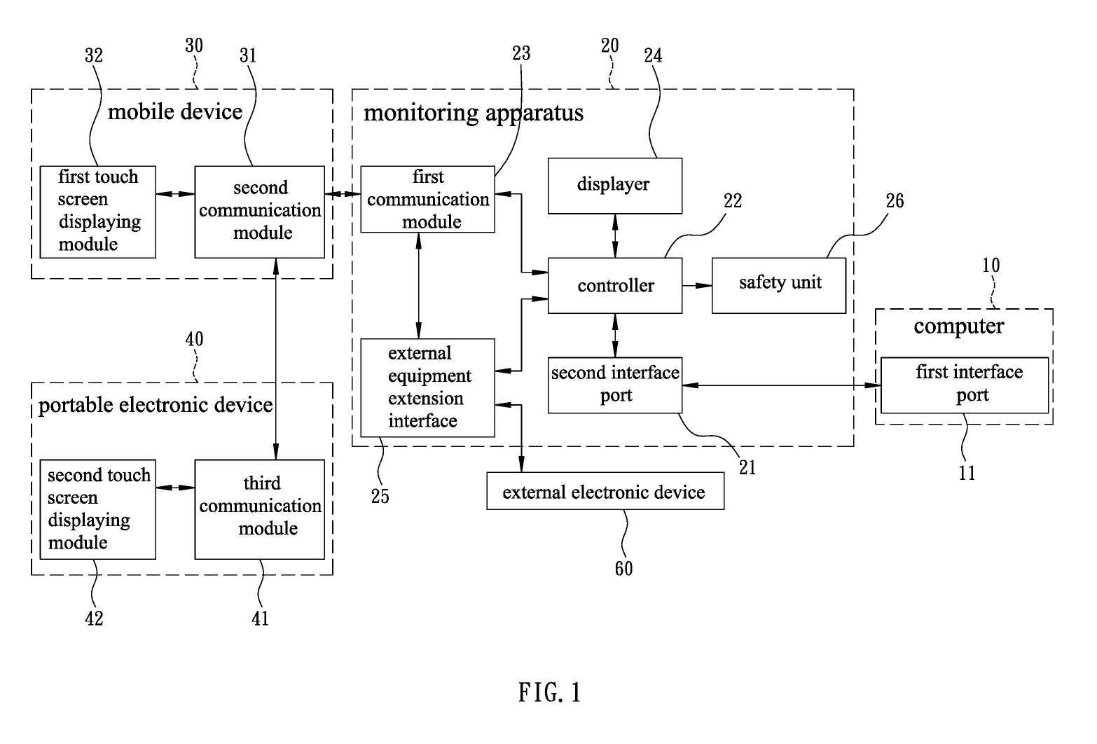

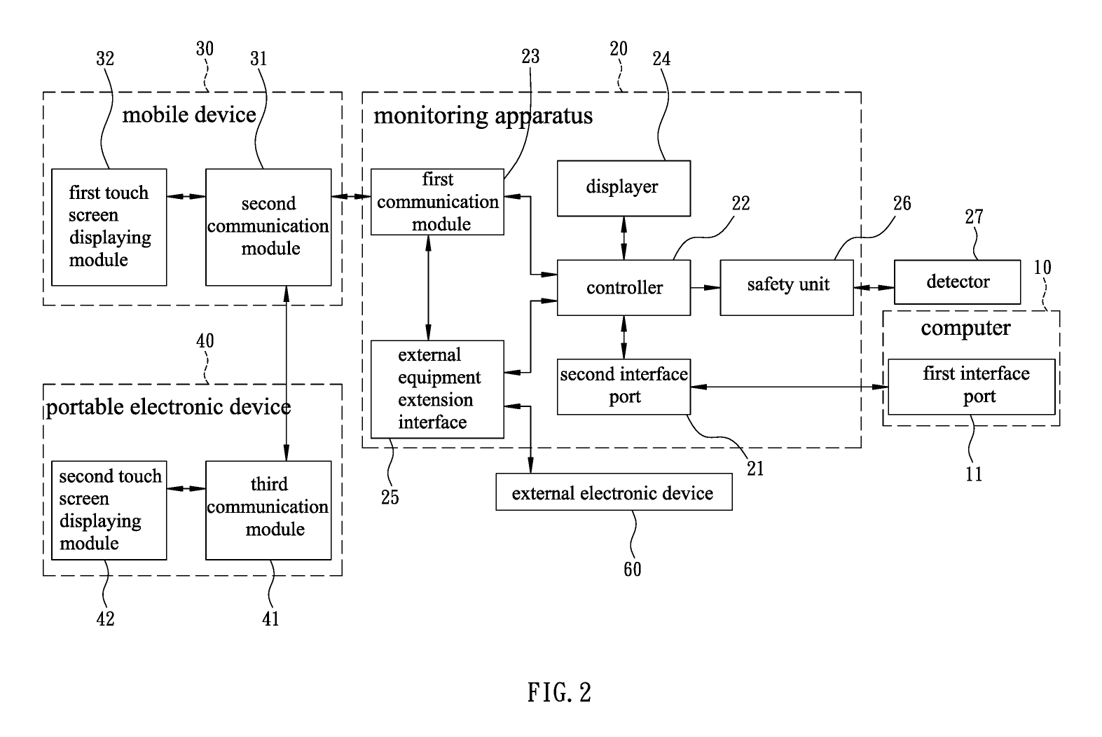

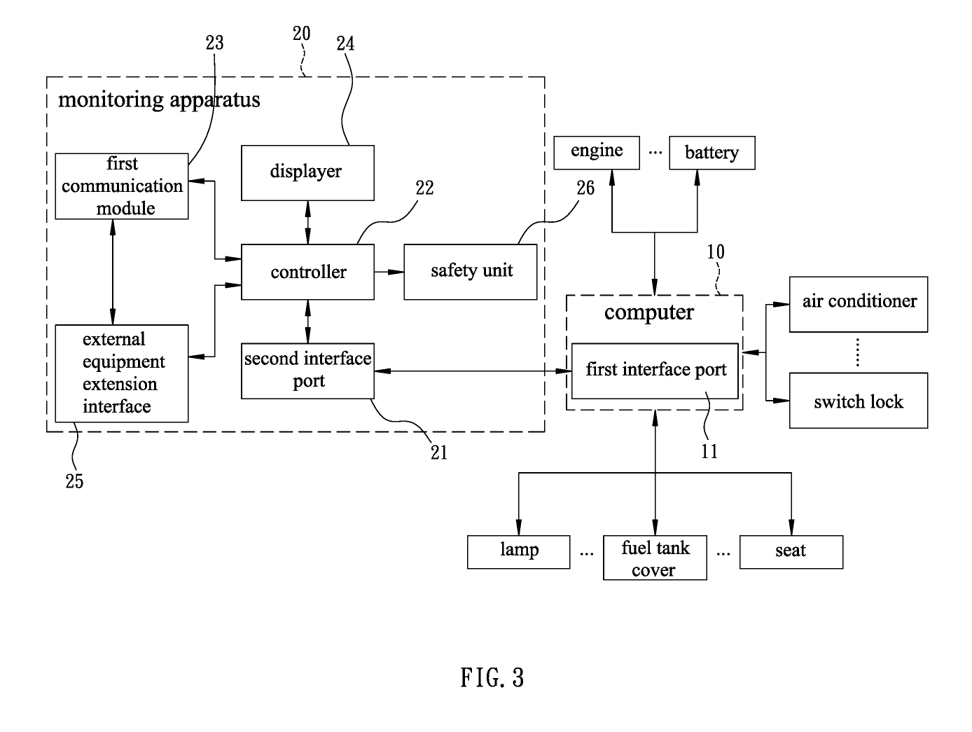

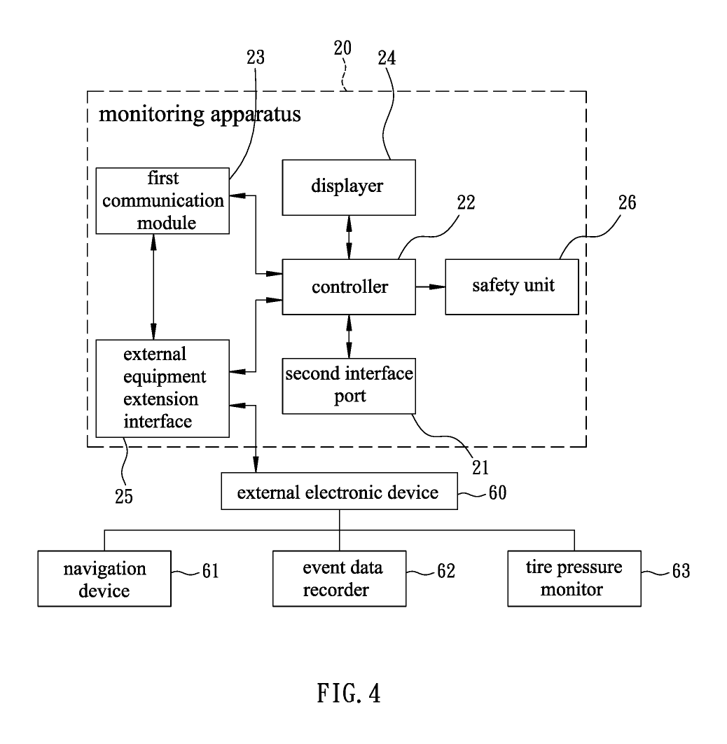

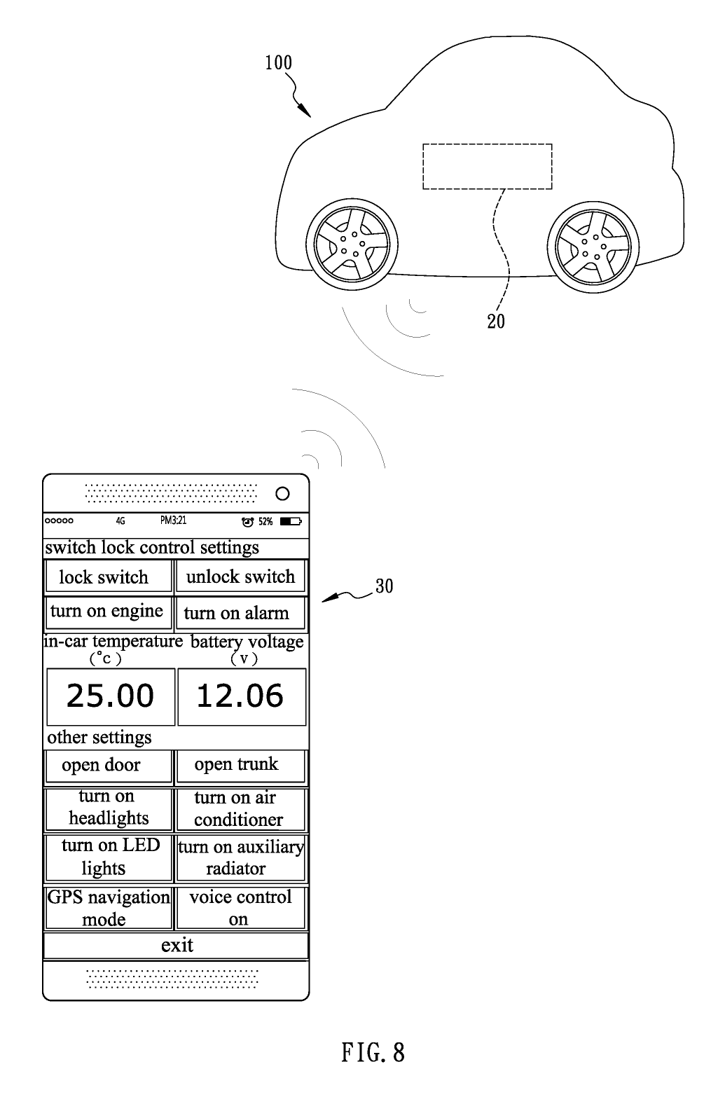

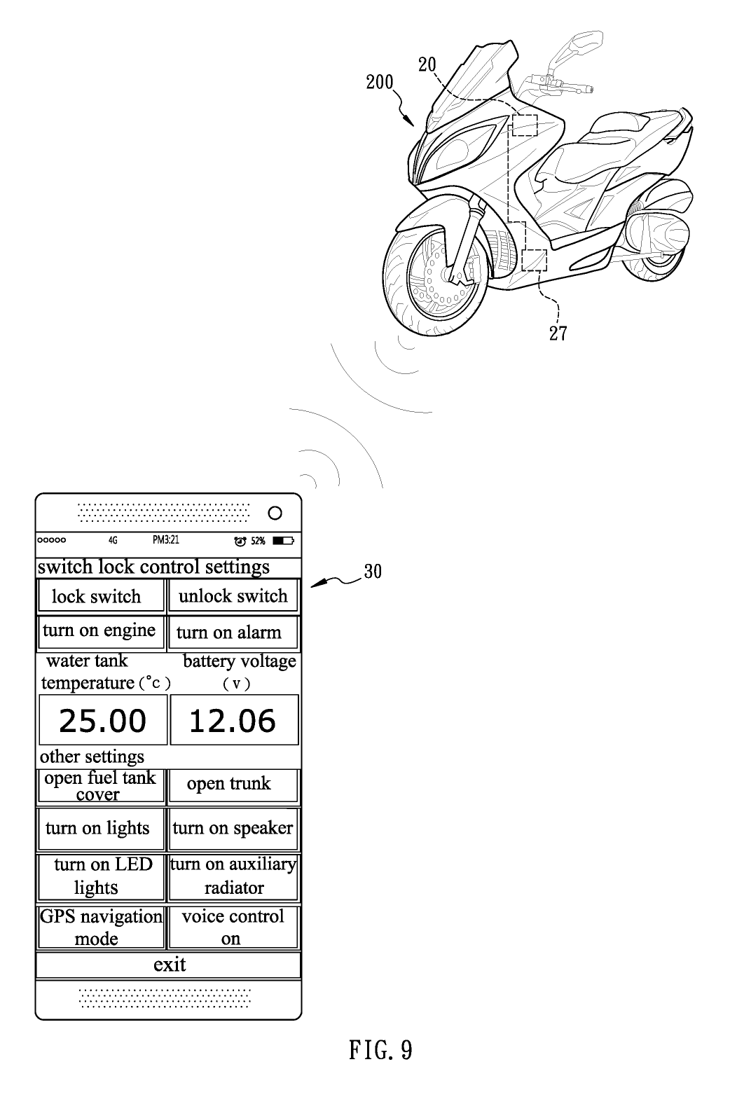

Referring to FIG. 1 to FIG. 9, embodiments of the present invention provide a vehicle/motorbike monitoring system and apparatus thereof, comprising a computer 10, a monitoring apparatus 20, a mobile device 30, and a portable electronic device 40. The monitoring apparatus 20 is connected with the computer 10 and the mobile device 30. The portable electronic device 40 is connected with the mobile device 30. When the monitoring apparatus 20 is connected with the computer 10, the monitoring apparatus 20 and the mobile device 30 are matched and allowed to exchange information with each other, such that the owner of the vehicle/motorbike is able to monitor the equipment status of the vehicle/motorbike, thus enhancing the safety and convenience of usage.

The computer 10 is installed in a vehicle/motorbike and connected with equipment of the vehicle/motorbike, such as air conditioner, switch lock, engine, lamp, and fuel tank cover or combinations of the above, thereby controlling and detecting the equipment status, and also generating a status signal based on the equipment status. The computer 10 is provided with a first interface port 11 and through which connected with the monitoring apparatus 20, such that the computer 10 sends the status signal to the monitoring apparatus 20. In the embodiments of the present invention, the vehicle refers to a car 100; the motorbike refers to a normal/heavy motorcycle 200; the first interface port 11 refers to an automotive connector.

The monitoring apparatus 20 is provided with a second interface port 21, a controller 22, a first communication module 23, and a displayer 24. The controller 22 is connected with the second interface port 21, the first communication module 23, and the displayer 24. The second interface port 21 is connected with the first interface port 11 to receive the status signal. When the second interface port 21 sends the status signal to the controller 22, the controller 22 processes the status signal and generates a corresponding status information.

The first communication module 23 is provided with a communication protocol and through which connected with the mobile device 30, such that the first communication module 23 and the mobile device 30 exchange information. The controller 22 sends the status information to the mobile device 30 and the displayer 24 through the first communication module 23. The displayer 24 thus displays the vehicle/motorbike equipment status. In the embodiments of the present invention, the first communication module 23 is a Bluetooth, and the communication protocol is Bluetooth protocol. The mobile device 30 is provided with a second communication module 31 which is also a Bluetooth module. The first communication module 23 is matched and connected with the second communication module 31 through the Bluetooth protocol, whereby the monitoring apparatus 20 only exchange information with the mobile device 30 which has been matched with the monitoring apparatus 20. Thus, the safety of information exchanging process is enhanced. The second interface port 21 is an automotive connector.

The monitoring apparatus 20 is further provided with an external equipment extension interface 25, which is connected with the controller 22 and the first communication module 23. The external equipment extension interface 25 is further connected to an external electronic device 60. In the embodiments of the present invention, the external electronic device 60 refers to a navigation device 61, an event data recorder 62, a tire pressure monitor 63, or combinations thereof.

The external equipment extension interface 25 receives the information sent from the first communication module 23 and sends the information to the external electronic device 60; alternatively, the external equipment extension interface 25 sends the information sent from the external electronic device 60 to the controller 22 to be processed, such that the vehicle/motorbike owner monitors the information of the external electronic device 60 through the mobile device 30.

In addition, the monitoring apparatus 20 is further provided with a safety unit 26 and a detector 27, wherein the safety unit 26 is electrically connected with the controller 22 and the detector 27. When the vehicle/motorbike is in a warning status, the safety unit 26 sends a warning signal to the mobile device 30 and triggers the mobile device 30 to display a warning alarm, thereby reminding the owner that the vehicle is in a status that the equipment are unable to be remotely controlled. The warning alarm includes a sound, a flash light or the combinations thereof. In the embodiments of the present invention, when applied on the car 100, the warning status refers to that the car gear is not shifted to P-gear. Regarding a normal/heavy motorcycle 200, the embodiments of the present invention provides a detector 27 on the body of normal/heavy motorcycle 200 for detecting a leaning status thereof. When applied on the heavy motorcycle 200, the warning status refers to that the heavy motorcycle gear is not shifted to N-gear or the body of the heavy motorcycle leans; when applied on the normal motorcycle, the warning status refers to that the body of the normal motorcycle leans.

The mobile device 30 is provided with a first touch screen displaying module 32, which is electrically connected with the second communication module 31. Also, the second communication module 31 is matched and connected with the first communication module 23, so as to receive the status information sent from the monitoring apparatus 20.

The mobile device 30 provides a monitoring software, which is operated by the vehicle/motorbike owner through the first touch screen displaying module 32 for displaying the status information thereon, such that the owner is able to know the equipment status of the vehicle/motorbike. In the embodiments of the present invention, the mobile device 30 refers to a smart phone or a tablet. Further, when the monitoring apparatus 20 is connected with the computer 10 on the vehicle/motorbike, the monitoring apparatus 20 and the mobile device 30 are matched and exchange information with each other, whereby the owner is able to monitor the equipment status on the vehicle/motorbike. Also, the mobile device 30 must be matched with the monitoring apparatus 20 through the communication protocol, thereby enabling the information exchanging process and allowing the owner to monitor the vehicle/motorbike status. As a result, the safety and convenience of usage are enhanced.

When the vehicle/motorbike owner wishes to change the status of any equipment on the vehicle/motorbike, the owner operates the monitoring software through the first touch screen displaying module 32, and the mobile device 30 sends a command information to the monitoring apparatus. The command information is then sent to the controller 22 through the first communication module 23. The controller 22 generates a controlling signal based on the command information, and sends the controlling signal to the first interface port 11. Subsequently, the computer 10 changes the equipment status according to the controlling signal, such as turning on/off the engine, turning on/off the air conditioner, locking/unlocking the switch, turning on/off the lamp, and covering/uncovering the fuel tank. Next, the computer 10 sends a status information feedback through the monitoring apparatus 20 to notify that the equipment status changes, such that the owner of the vehicle/motorbike is able to know through the mobile device 30 that the equipment status has been changed.

Further, if the monitoring apparatus 20 receives a status signal referring to the equipment status changing while not receiving the command information sent from the mobile device 30, the monitoring apparatus 20 correspondingly sends an abnormality signal to the mobile device 30, so as to notify the vehicle/motorbike owner that an abnormal situation has occurred, thereby enhancing the safety of the vehicle/motorbike. In the embodiments of the present invention, the abnormality information presented on the mobile device 30 for notifying the owner of an abnormality situation refers to a sound alarm or a change of the background colors of the first touch screen displaying module 32.

The portable electronic device 40 is provided with a third communication module 41 and a second touch screen displaying module 42. The portable electronic device 40 provides a monitoring software. The third communication module 41 is matched and connected with the second communication module 31 of the mobile device 30 through the communication protocol. In the embodiments of the present invention, with the mobile device 30 as a controlling platform, the vehicle/motorbike owner is able to operate the monitoring software through the second touch screen displaying module 42 of the portable electronic device 40 for generating the corresponding information which is then sent to the monitoring apparatus 20 through the mobile device 30, whereby the computer 10 changes the vehicle/motorbike equipment status. In the embodiments of the present invention, the portable electronic device 40 refers to a wearable electronic device, such as a smart watch. The third communication module 41 is a Bluetooth module.

In addition, the monitoring apparatus 20 also provides a monitoring software. The displayer 24 is not only able to display the current equipment status, but also is provided with a touch-to-operate function, such that the vehicle/motorbike owner operates the monitoring software by operating the displayer 24. Also, the owner is able to operate the monitoring software through the displayer 24 for triggering the controller 22 to send a corresponding controlling signal to the computer 10 through the second interface port 21, thereby changing the vehicle/motorbike equipment status.

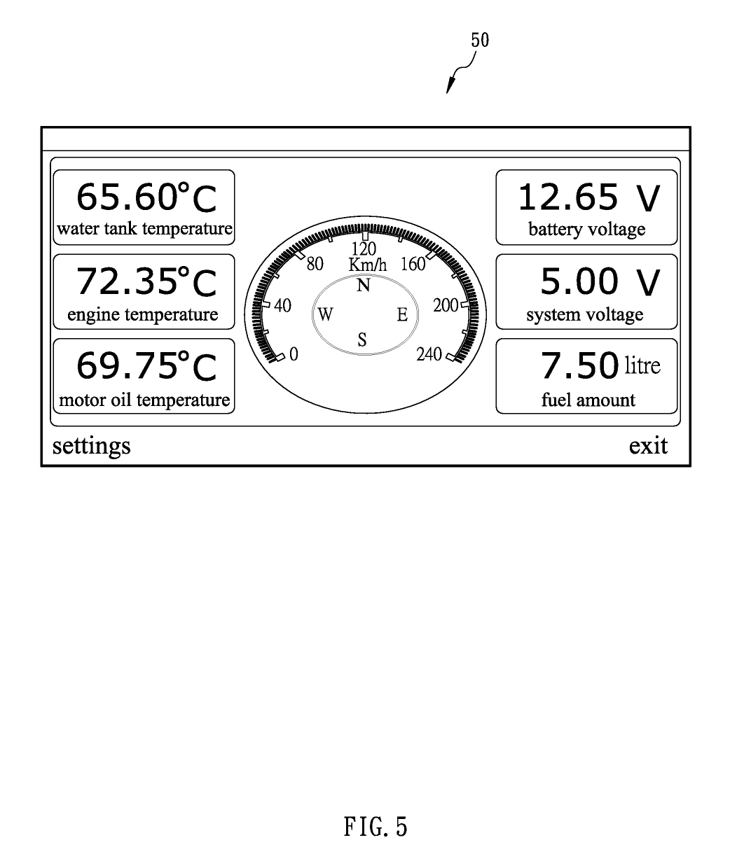

Referring to FIG. 1 and FIG. 5, the monitoring software is provided with a vehicle/motorbike information displaying interface 50. The vehicle/motorbike owner operates the monitoring software through the first touch screen displaying module 32 of the mobile device 30 for turning on the vehicle/motorbike information displaying interface 50, such that the first touch screen displaying module 32 displays various information such as the vehicle/motorbike speed, direction, water tank temperature, engine temperature, motor oil temperature, battery voltage, system voltage, and fuel reservation amount in the fuel tank. When at least one of the water tank temperature, engine temperature, motor oil temperature, battery voltage, and system voltage appears to be abnormal, the monitoring apparatus 20 sends a corresponding abnormality information to the mobile device 30 to notify the owner of the abnormal situation of the vehicle/motorbike. Therefore, the safety of the vehicle/motorbike is enhanced.

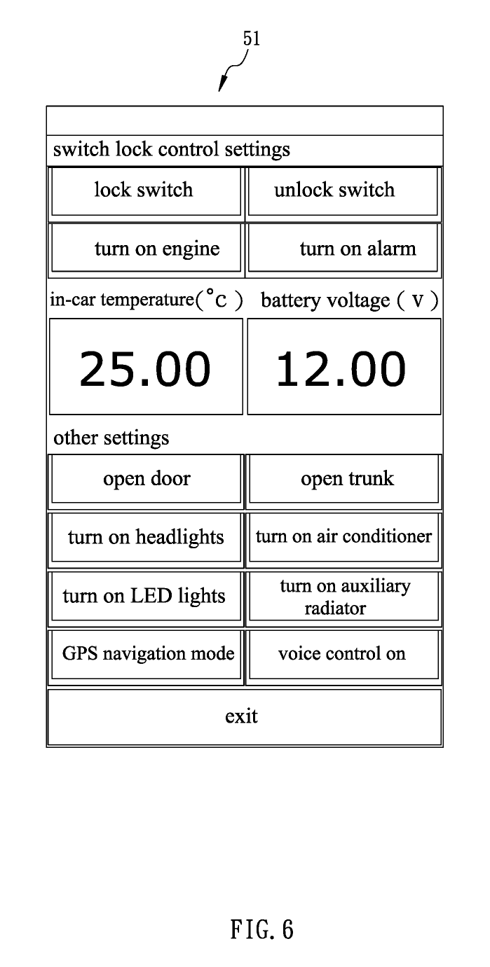

Referring to FIG. 1 and FIG. 6, for enabling the software to control the vehicle/motorbike that are connected to the computer 10, the monitoring software is further provided with a controlling interface 51 having plural virtual buttons, including a door lock button, a temperature button, a voltage button, and a lamp button. After the vehicle/motorbike owner operates the monitoring software through the first touch screen displaying module 32 to turn on the controlling interface 51, the owner further operates the plural virtual buttons on the controlling interface 51 through the first touch screen displaying module 32 in order to have the computer 10 lock/unlock the door lock, turn on/off the engine, turn on/off the vehicle/motorbike alarm mechanism, or modulate the abnormal output voltage and water tank temperature. In other words, the vehicle/motorbike equipment status is controllable through the controlling interface 51 of the monitoring software.

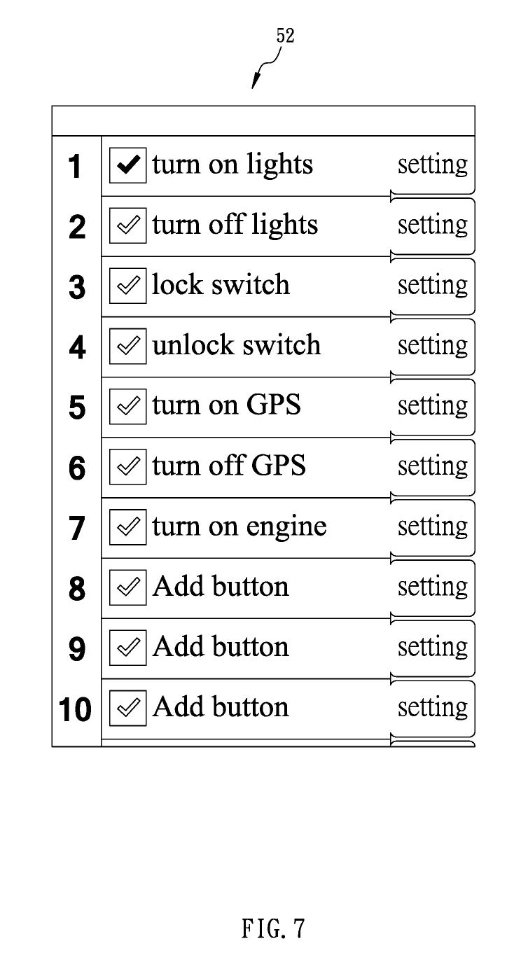

Referring to FIG. 7, the monitoring software is further provided a function setting interface 52, which provides various virtual buttons among which the owner chooses. After the owner chooses the buttons to be utilized, the controlling functions of the buttons are activated by checking the corresponding button items which are then marked with colors. With such configuration, the controlling function of the monitoring software is modified by the owner, thus providing a flexibility of usage.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle and motorbike monitoring system, comprising:
a computer, provided with a first interface port, installed on a vehicle/motorbike, outputting a status signal based on a status of equipment of a vehicle/motorbike;
a monitoring apparatus, provided with a second interface port, a controller, a first communication module, and a displayer; the controller is connected to the second interface port, the first communication module, and the displayer; the second interface port is connected to the first interface port, wherein the second interface port receives the status signal and sends the status signal to the controller; the controller outputs a status information based on the status signal; the displayer displays the status of equipment of the vehicle/motorbike; and
a mobile device, provided with a second communication module and a first touch screen displaying module, the second communication and the monitoring apparatus connected and exchanging information with each other through a communication protocol, the second communication module receiving the status information and sending the status information to the first touch screen displaying module to be displayed on the first touch screen displaying module, wherein the mobile device sends a command information to the monitoring apparatus through the communication protocol based on the status information, and the controller generates a controlling signal based on the command information and sends the controlling signal to the first interface port though the second interface port, such that the computer, based on the controlling signal, commands the status of the corresponding equipment on the vehicle/motorbike to change.

2. The monitoring system of claim 1, wherein the mobile device provides a monitoring software; when the monitoring software is operated through the first touch screen displaying module to send a corresponding command information to the monitoring device, the monitoring device, based on the command information, correspondingly sends a controlling signal to the computer on the vehicle/motorbike, such that the corresponding equipment status of the vehicle/motorbike changes, and the computer sends a status information feedback through the monitoring apparatus to notify that the corresponding equipment status changes.

3. The monitoring system of claim 1, wherein if the monitoring apparatus receives a status signal referring to the equipment status changing without receiving the command information sent from the mobile device, the monitoring apparatus correspondingly send an abnormality signal to the mobile device.

4. The monitoring system of claim 2, wherein the monitoring apparatus provides the monitoring software, and the displayer is provided with a touch-to-operate function; the monitoring software is operated through the displayer to display the equipment status of the vehicle/motorbike; the controlling signal corresponding to the certain equipment is sent to the computer through the second interface port, such that the corresponding equipment status of the vehicle/motorbike changes.

5. The monitoring system of claim 1, wherein the monitoring system is further provided with an external equipment extension interface, which is connected with the controller and the first communication module; the external equipment extension interface is connected with at least one external electronic device, such that the mobile device monitors the external electronic device.

6. The monitoring system of claim 1, wherein the monitoring system is further provided with a safety unit connected with the controller; when the vehicle/motorbike is in a warning status, the safety unit sends a warning signal to the mobile device, and a warning alarm is displayed on the first touch screen displaying module.

7. The monitoring system of claim 6, wherein the warning alarm is chosen from a group consisting of a sound, a flash light, and a combination thereof.

8. The monitoring system of claim 5, further comprising a portable electronic device provided with a third communication module and a second touch screen displaying module and also providing the monitoring software; the third communication module is connected with the mobile device through the communication protocol; the second touch screen displaying module is for operating the monitoring software.

9. The monitoring system of claim 2, wherein the monitoring software is further provided with an information displaying interface, a controlling interface, and a function setting interface; the information displaying interface displays the equipment status of the vehicle/motorbike; the controlling interface controls the equipment status of the vehicle/motorbike and send the command information to the monitoring apparatus through the mobile device for the corresponding equipment status to change; the function setting interface is used to set up various function of the monitoring software.

10. The monitoring system of claim 8, wherein the external electronic device is chosen from a group consisting of a navigation device, an event data recorder, a tire pressure monitor and combinations thereof; the first communication module is a Bluetooth module, the communication protocol is a Bluetooth protocol; the mobile device is chosen from a group consisting of a smart phone and a tablet; the portable electronic device is chosen from a group consisting of a smart phone and a tablet.

11. A monitoring apparatus, comprising:
a first communication module, provided with a communication protocol;
a second interface port, connected with a computer installed on a vehicle/motorbike;
a controller, electrically connected with the second interface port and the first communication module, the second interface port receiving a status signal which is then sent to the controller, the controller send a status information to a receiving end through the communication protocol based on the status signal;
a displayer, displaying an equipment status of the vehicle/motorbike,
wherein the controller receives a command information of the receiving end through the communication protocol, and generates a controlling signal based on the command information; the controlling signal is then sent to the computer through the second interface port, triggering the corresponding equipment status of the vehicle/motorbike to change.

12. The monitoring apparatus of claim 11, wherein if the controller receives a status signal sent from the computer on the vehicle/motorbike which refers to the equipment status changing without receiving the command information sent from the receiving end, the controller correspondingly sends an abnormality signal to the receiving end.

13. The monitoring apparatus of claim 11, further comprising a safety unit electrically connected with the controller; when the vehicle/motorbike is in a warning status, the safety unit sends a warning signal to the receiving end, and a warning alarm is displayed on the receiving end.

14. The monitoring apparatus of claim 13, the warning alarm is chosen from a group consisting of a sound, a flash light, and a combination thereof.
